(19) United States
(12) Patent Application Publication
(10) Pub. No.: US 2025/0303971 A1
(43) Pub. Date: Oct. 2, 2025

(54) REVERSIBLE VEHICLE TRUNK RACK

(71) Applicant: Guangzhou Issyzone Technology Co., Limited, GUANGZHOU (CN)

(72) Inventors: Zhuo Jia, Guangzhou (CN); Taiping Yang, Guangzhou (CN); Jun Xiao, Guangzhou (CN)

(21) Appl. No.: 18/921,003

(22) Filed: Oct. 21, 2024

(30) Foreign Application Priority Data
Mar. 28, 2024 (CN) 2024206281582

(51) Int. Cl. B60R 7/02

(52) U.S. Cl. CPC B60R 7/02

(57) ABSTRACT

This invention is about a reversible vehicle trunk rack, including a first supporting board, a second supporting board, and a storage board. In this utility model, the storage board is fitted with the rotatable connecting piece, so that the installation height of the storage board can be adjusted as required. When large objects need to be put in the trunk, only the supporting arm needs to be loosen and rotated upward, to rotate the storage board to a top of the trunk and lock the supporting arm, so that the trunk has enough storage space. When no large objects need to be put in the trunk, only the supporting arm needs to be loosen and rotated downward, to hang the storage board in the trunk and lock the supporting arm, so that the storage board is in a state of storing objects.

### CROSS REFERENCE TO RELATED APPLICATIONS

The present application claims the priority of Chinese patent application No. 2024206281582, filed on Mar. 28, 2024, and contents of which are incorporated herein by reference.

### TECHNICAL FIELD

This utility model relates to the technical field of developing additional parts of vehicles, and specifically refers to a reversible vehicle trunk rack.

### TECHNICAL BACKGROUND

A vehicle trunk rack is one type of additional part of vehicles, and is favored by virtue of its capability of providing fine storage space for drivers and passengers. However, because existing vehicle trunk racks on the market are all fixed structures, that is, installed at fixed heights, after the trunk racks are installed, loading space of the vehicle trunks is confined. If a user needs to put a large object into the vehicle trunk, the user needs to remove the rack, and when needing to use the rack, the user has to reinstall the rack, which is extremely inconvenient to the user. Therefore, obviously, the existing vehicle trunk racks are nonadjustable in terms of installation heights, and can no longer meet people's needs. In view of this, a vehicle trunk rack adjustable in terms of its installation height needs to be designed, so that the vehicle trunk rack does not need to be disassembled when large objects need to be put into the vehicle trunk, thereby providing fine storage space for users.

### SUMMARY

This utility model is intended to provide a reversible vehicle trunk rack adjustable in terms of heights through reversion after installation, to overcome a disadvantage that existing vehicle trunk racks are nonadjustable in terms of installation heights.

An objective of this utility model is achieved through the following technical solution: A reversible vehicle trunk rack includes a first supporting board, a second supporting board, and a storage board having an end flexibly disposed on the first supporting board through a connecting piece and another end flexibly disposed on the second supporting board through a connecting piece, where the storage board is hinged with the connecting piece through a locking bolt; and the first supporting board and the second supporting board are flexibly or fixedly connected with the connecting piece respectively, the connecting piece can be rotated or vertically fixed on the first supporting board and the second supporting board, and the storage board can constantly remain in a horizontal state when the connecting piece is rotated.

Further, the connecting piece consists of two supporting arms, the two supporting arms are symmetrically disposed, and there is a gap between the two supporting arms.

In a preferred solution of this utility model, in order that the connecting piece is in a fixed state after being rotated, a fixing bolt is disposed on one supporting arm of the connecting piece, and the fixing bolt is threaded or plugged into the first supporting board and the second supporting board after penetrating the supporting arm.

In a preferred solution of this utility model, the number of locking bolts is four, the four locking bolts are threaded into the supporting arms of the two sets of connecting pieces one to one, the locking bolts are threaded into the supporting arms after penetrating the storage board, and the storage board is hinged with the locking bolt.

In a preferred solution of this utility model, in order that the entire trunk rack is connected and fixed to the vehicle trunk, the first supporting board and the second supporting board each are provided with an installation and fixing board and clamping arms; and the number of clamping arms is more than one.

The first supporting board and the second supporting board each are also respectively provided with two positioning holes fitting the fixing bolts, the two positioning holes are vertically and symmetrically disposed, and there is a gap between the two positioning holes; and the fixing bolts are threaded or plugged into the positioning holes.

In a preferred solution of this utility model, the storage board consists of one or two grooved boards with edges; and when the storage board consists of two grooved boards, the two grooved boards are fixed and connected through a connecting board.

Compared with the prior art, this utility model has the following advantages and beneficial effects:

In this utility model, the storage board is fitted with the rotatable connecting piece, so that the installation height of the storage board can be adjusted as required. When large objects need to be put in the trunk, only the supporting arm needs to be loosen and rotated upward, to rotate the storage board to a top of the trunk and lock the supporting arm, so that the trunk has enough storage space. When no large objects need to be put in the trunk, only the supporting arm needs to be loosen and rotated downward, to hang the storage board in the trunk and lock the supporting arm, so that the storage board is in a state of storing objects, thereby adjusting storage space of the trunk without removing the rack. Therefore, the problem that the installation heights of the existing trunk racks are nonadjustable is well resolved, which makes the rack more convenient to use.

### BRIEF DESCRIPTION OF THE DRAWINGS

FIG. 1 is a schematic structural diagram of a storage board at a high position in this utility model.

FIG. 2 is a schematic structural diagram of a storage board at a low position in this utility model.

Names of reference signs in the foregoing drawings are as follows:
1—first supporting board, 2—clamping arm, 3—supporting arm, 4—storage board, 5—locking bolt, 6—second supporting board, 7—connecting board, 8—fixing bolt, 9—installation and fixing board, and 10—positioning hole.

### DETAILED DESCRIPTION OF EMBODIMENTS

This utility model is further described in detail below with reference to specific embodiments, but embodiments of this utility model are not limited thereto.

### Embodiment 1

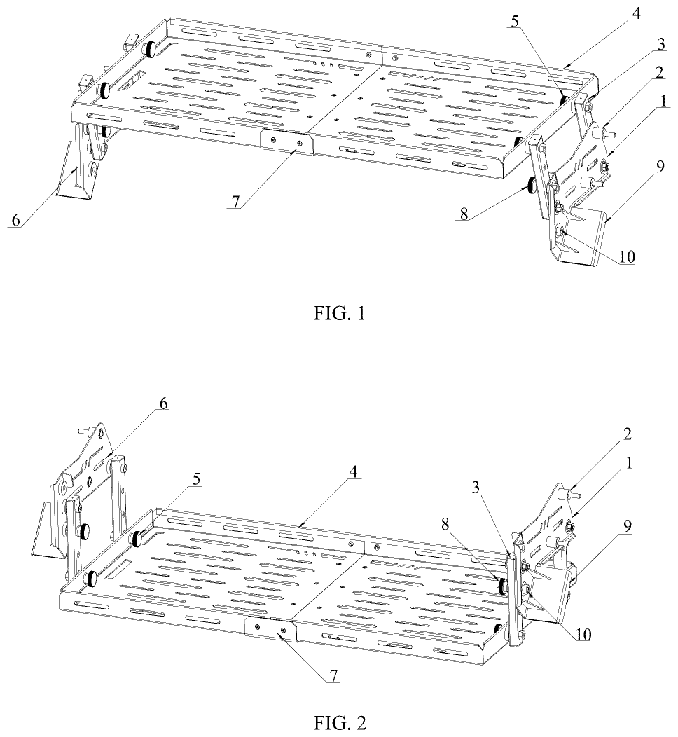

As shown in FIG. 1 and FIG. 2, a reversible vehicle trunk rack in this utility model includes a first supporting board 1, a second supporting board 6, and a storage board 4. Specifically, the first supporting board 1 and the second supporting board 6 are used as supporting bodies of the rack, and when used, the first supporting board 1 and the second supporting board 6 are symmetrically installed on two sides of the vehicle trunk. To facilitate installation, the installation and fixing boards 9 and the clamping arms 2 are installed on both the first supporting board 1 and the second supporting board 6, where the number of clamping arms 2 is more than one. In this embodiment, the number of clamping arms 2 is preferentially set to two. When installed, the installation and fixing boards 9 and the clamping arms 2 are fixed in installation groove holes disposed on two sides of the trunk in advance, and the installation and fixing boards 9 and the clamping arms 2 are respectively plugged into the installation groove holes disposed on the two sides of the trunk in advance.

The storage board 4 consists of one or two grooved boards with edges. The storage board 4 in this embodiment preferentially consists of two grooved boards, to facilitate transportation and storage of the rack. When installed, the two grooved boards are fixed and connected through the connecting board 7.

As shown in FIG. 1, the storage board 4 has an end flexibly disposed on the first supporting board 1 through a connecting piece and another end flexibly disposed on the second supporting board 6 through a connecting piece. When installed, the storage board 4 is hinged with the connecting piece through a locking bolt 5, that is, the locking bolt 5 is threaded or plugged into the connecting piece after penetrating the storage board 4. The storage board 4 can be rotated along a bolt arm of locking bolt 5. The first supporting board 1 and the second supporting board 6 are flexibly or fixedly connected with the connecting piece respectively, and the connecting piece can be rotated or vertically fixed on the first supporting board 1 and the second supporting board 6. Specifically, when the installation height of the storage board 4 needs to be adjusted, the connecting piece is flexibly connected with the first supporting board 1 and the second supporting board 6, the connecting piece can be rotated on the first supporting board 1 and the second supporting board 6, and when the connecting piece is rotated, the storage board 4 constantly remains in a horizontal state. After the storage board 4 is adjusted to a required height, the storage board 4 is fixed on the first supporting board 1 and the second supporting board 6, and the storage board 4 is in a vertical state.

The connecting piece consists of two supporting arms 3. Specifically, the two supporting arms 3 are symmetrically disposed, and there is a gap between the two supporting arms 3. When installed, the supporting arm 3 has one end threaded with the locking bolt 5 and another end hinged with the first supporting board 1 and the second supporting board 6 through a connecting pin, so that the supporting arm 3 is rotatable.

To facilitate the fixing of the supporting arm 3, a fixing bolt 8 is disposed in one supporting arm 3 of the connecting piece. The fixing bolt 8 is threaded into the first supporting board 1 and the second supporting board 6 after penetrating the supporting arm 3. The first supporting board 1 and the second supporting board 6 each are also respectively provided with two positioning holes 10 fitting the fixing bolts 8, the two positioning holes 10 are vertically and symmetrically disposed, and there is a gap between the two positioning holes 10. Specifically, a positioning hole 10 is located at an upper end of the first supporting board 1 and the second supporting board 6, and the other positioning hole 10 is located at a lower end of the first supporting board 1 and the second supporting board 6. The fixing bolts 8 are threaded or plugged into the positioning holes 10. During use, when the installation height of the storage board 4 needs to be adjusted, the fixing bolt 8 is removed from the positioning hole 10, so that the supporting arm 3 can be rotated. When the installation height of the storage board 4 is adjusted to the required height, that is, the storage board 4 is located at the top of the trunk or hung in the trunk, the fixing bolt 8 is inserted or screwed into the positioning hole 10, so that the supporting arm 3 and the storage board 4 can be fixed and positioned.

In addition, to better install the storage board 4 horizontally, the number of locking bolts 5 is set to four. The four locking bolts 5 are threaded into the supporting arms 3 of the two sets of connecting pieces one to one, the locking bolts 5 are threaded into the supporting arms 3 after penetrating the storage board 4, and the storage board 4 is hinged with each locking bolt 5.

### Embodiment 2

Contents of this embodiment and Embodiment 1 are basically the same, and a difference is that the storage board 4 is an integrated grooved board with an edge.

In this utility model, during specific use, the storage board 4 is fitted with the rotatable connecting piece, so that the installation height of the storage board 4 can be adjusted as required. When large objects need to be put in the trunk, only the fixing bolts 8 need to be removed from the positioning holes 10 at the lower ends of the first supporting board and the second supporting board, and the supporting arm 3 is rotated upward, to rotate the storage board 4 to a top of the trunk and further lock the fixing bolts 8 into the positioning holes 10 at the upper ends of the first supporting board and the second supporting board, so that the trunk has enough storage space. When no large objects need to be put in the trunk, only the fixing bolts 8 need to be removed from the positioning holes 10 at the upper ends of the first supporting board and the second supporting board, and the supporting arm 3 is rotated downward, to hang the storage board 4 in the trunk and further lock the fixing bolts 8 into the positioning holes 10 at the lower ends of the first supporting board and the second supporting board, so that the storage board 4 is in a state of storing objects.

As described above, this utility model can be well implemented.

This utility model discloses a reversible vehicle trunk rack, including a first supporting board (1), a second supporting board (6), and a storage board (4). In this utility model, the storage board is fitted with the rotatable connecting piece, so that the installation height of the storage board can be adjusted as required. When large objects need to be put in the trunk, only the supporting arm needs to be loosen and rotated upward, to rotate the storage board to a top of the trunk and lock the supporting arm, so that the trunk has enough storage space. When no large objects need to be put in the trunk, only the supporting arm needs to be loosen and rotated downward, to hang the storage board in the trunk and lock the supporting arm, so that the storage board is in a state of storing objects, thereby adjusting storage space of the trunk without removing the rack. Therefore, the problem that the installation heights of the existing trunk racks are nonadjustable is well resolved, which makes the rack more convenient to use.

What is claimed is:

1. A reversible vehicle trunk rack, comprising a first supporting board (1), a second supporting board (6), and a storage board (4) having an end flexibly disposed on the first supporting board (1) through a connecting piece and another end flexibly disposed on the second supporting board (6) through a connecting piece, wherein the storage board (4) is hinged with the connecting piece through a locking bolt (5); and the first supporting board (1) and the second supporting board (6) are flexibly or fixedly connected with the connecting piece respectively, the connecting piece can be rotated or vertically fixed on the first supporting board (1) and the second supporting board (6), and the storage board (4) can constantly remain in a horizontal state when the connecting piece is rotated.

2. The reversible vehicle trunk rack according to claim 1, wherein the connecting piece consists of two supporting arms (3), the two supporting arms (3) are symmetrically disposed, and there is a gap between the two supporting arms (3).

3. The reversible vehicle trunk rack according to claim 2, wherein a fixing bolt (8) is disposed on one supporting arm (3) of the connecting piece, and the fixing bolt (8) is threaded or plugged into the first supporting board (1) and the second supporting board (6) after penetrating the supporting arm (3).

4. The reversible vehicle trunk rack according to claim 3, wherein the number of locking bolts (5) is four, the four locking bolts (5) are threaded into the supporting arms (3) of the two sets of connecting pieces one to one, the locking bolts (5) are threaded into the supporting arms (3) after penetrating the storage board (4), and the storage board (4) is hinged with the locking bolt (5).

5. The reversible vehicle trunk rack according to claim 4, wherein the first supporting board (1) and the second supporting board (6) each are provided with an installation and fixing board (9) and clamping arms (2); and the number of clamping arms (2) is more than one.

6. The reversible vehicle trunk rack according to claim 5, wherein the first supporting board (1) and the second supporting board (6) each are also respectively provided with two positioning holes (10) fitting the fixing bolts (8), the two positioning holes (10) are vertically and symmetrically disposed, and there is a gap between the two positioning holes (10); and the fixing bolts (8) are threaded or plugged into the positioning holes (10).

7. The reversible vehicle trunk rack according to claim 1, wherein the storage board (4) consists of one or two grooved boards with edges; and when the storage board (4) consists of two grooved boards, the two grooved boards are fixed and connected through a connecting board (7).
